(19) United States
(12) Patent Application Publication
(10) Pub. No.: US 2011/0042971 A1
(43) Pub. Date: Feb. 24, 2011

(54) Electronic Door Chain

(75) Inventors: George Youssef, Newhall, CA (US); Diana Sidrak, Van Nuys, CA (US)

Correspondence Address: MG & B Engineering Inc., 25031 Peachland Avenue #267, NEWHALL, CA, 91321, US

(73) Assignee: MG&B Engineering Inc, Newhall, CA (US)

(21) Appl. No.: 12/545,830

(22) Filed: Aug. 23, 2009

(51) Int. Cl. E05C 17/36

(52) U.S. Cl. 292/264

(57) ABSTRACT

An electronic door chain which has a receiving hole drilled into the slotted keeper for a electric solenoid shaft to be inserted into which will prevent sliding of the chain out of the groove unless the solenoid is released by entering a pre-programmed access number on the access keypad in which case the solenoid shaft is retracted in response to the access keypad output. Concurrently, the solenoid shaft will retract to the open position and a short beep will be generated to announce to anyone within hearing distance that the electronic door chain is disengaged.

### FIELD OF THE INVENTION

The present invention relates to improvements on conventional door chains using pre-programmed access codes and can be used on doors in commercial and residential dwellings.

### BACKGROUND OF THE INVENTION

Prior to the conception of the present invention, available door chain devices do not protect from several elements. Any child able to climb on a chair is capable of unlatching a door chain (traditional or maze) and opening a door, which poses a great risk on their lives and to the safety of anyone in the room unaware of the open door. It is also possible for someone on the outside of a door to slide their hand inside the door and release the chain from the groove and therefore enter the dwelling, which poses a threat on occupants' lives and their valuables.

### SUMMARY OF THE INVENTION

The present invention provides solutions to multiple drawbacks of an ordinary door chain. The Electronic Door Chain consists of a -slightly modified traditional door chain, an electric solenoid or any linear actuation mechanism, an alarm or any alerting device, a battery pack or any power source capable of powering the design and an access keypad. Although, it is apparent to anyone skilled in the art that any linear actuation mechanism will work; the current invention uses an electric solenoid. The door chain is modified by drilling a receiving hole for the electric solenoid shaft to be inserted into which will prevent sliding the chain out of the groove unless the solenoid is released by entering a pre-programmed access number on the access keypad in which case the solenoid shaft is retracted in response to the access keypad output. Concurrently, the solenoid shaft will retract to the open position and a short beep will be generated to announce to anyone in the room that the electronic door chain is open.

The above process of disengaging the electronic door chain provides solutions to the many drawbacks of an ordinary door chain. The Electronic Door Chain prevents toddlers and children from opening the door without their parents' being aware because they have to enter an access code to disengage the solenoid shaft and remove the chain. Moreover, if they are successful in entering the code, a sound alarm is activated every time the electronic door chain is released to alert others in the residence.

Also, an intruder from the outside cannot enter the code from the outside and remove the chain to gain access to the dwelling. This means that adults not only have control from the inside and can protect their children, but this also adds a sense of confidence that an unwanted intruder cannot simply reach in and release the chain.

### OBJECTS OF THE INVENTION

It is one of the primary objectives of the present invention to provide increased protection to a residential dwelling or commercial location.

In addition to the object and advantage of the present invention described with some specificity above, it should be obvious that additional objects and advantages of the present invention will become more readily apparent to those persons who are skilled in the relevant art from the following more detailed description of the invention, particularly, when such description is taken in conjunction with the attached drawings and with the appended claim.

### BRIEF DESCRIPTION OF THE DRAWINGS

FIG. 1 is the frontal perspective view of the Electronic Door Chain.

FIG. 2 is a rear perspective view of the housing of the Electronic Door Chain.

### DETAILED DESCRIPTION OF A PRESENTLY PREFERRED EMBODIMENT OF THE INVENTION

Prior to proceeding to the more detailed description of the present invention it should be noted that, for the sake of clarity and understanding, identical components which have identical functions have been identified with identical reference numerals throughout the several views illustrated in the drawings.

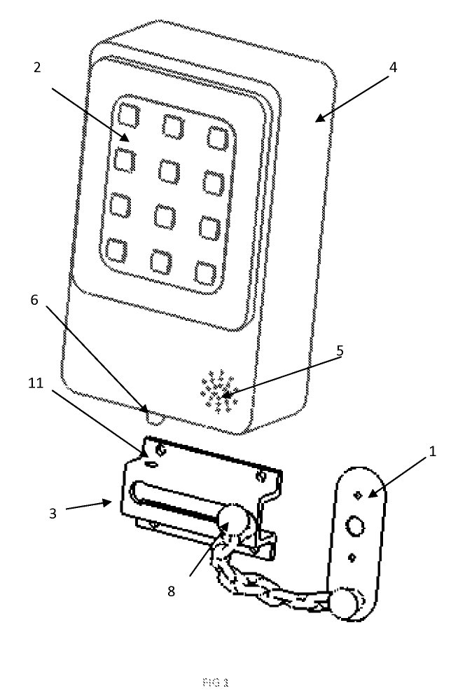

Referring initially to FIG. 1, the frontal perspective view of the Electronic Door Chain is shown. In this view, the main enclosure 4 is made out of Aluminum 6061-T-6 for example, and can be anodized to different colors to fit any residential or commercial interior. The original design is black anodized because it prevents Aluminum oxidization (dullness), improves appearance, and protects against harsh environments. However, using other materials such as plastic, metals, or plastic metal hybrids can be done to satisfy safety and manufacturing requirements. It is apparent to one who is skilled in the art that changing the housing materials will not affect the performance of the device.

The access keypad 2 in FIG. 1 is a pre-manufactured 50 user programmable entry code pad. There are 4, 5 or 6 digit entry codes indexed for secure allocation and re-allocation of entry codes. The selected access keypad uses a timed release or latching operation depending on how it is wired and operates at 12 VDC. The access keypad is weather resistant to IP65 standards and is wired as a “normally closed” circuit with the solenoid and the beeper connected in parallel to a relay terminal on the output of the keypad. Other keypads are also available and can be used without changing the scope of the invention.

The speaker 5 in FIG. 1, will be connected in parallel with the solenoid to alert the user when the access code is accepted and the solenoid shaft is then retracted. The main purpose of the speaker is to inform the user that the chain is ready to slide out of the groove in the slotted keeper 3. The speaker is a solid-state audio indicator and emits a medium-loud, high-pitched tone. A screwdriver adjustable trimmer on back of device controls volume. The speaker will operate on 9 VDC at 6 mA. The black plastic face is 1.45″ diameter×0.16″ thick. A 1.25″ diameter threaded mounting bushing with large plastic nuts mounted in panels up to 0.5″ thick. The connection is 0.187″ soldered terminals, which will be connected to the access keypad output and will be activated simultaneously with the solenoid shaft 6 and will be mounted on the main enclosure 4. To ensure that the speaker supply is 9 VDC, a 9 VDC voltage regulator (chip number L7809AB) can be implemented in the circuit between the battery output and the speaker input with the appropriate resistance to limit the current at 6 mA. As any linear actuation mechanism and alarming device combination can be used; any other regulation devices or schemes can be adopted without changing the functionality of the device.

Below the main enclosure is the door frame holding bracket 1, the slotted keeper 3, the pin 8, and the drilled hole 11. The chain used here uses six #6-1″ Phillips slot flat head screws to fasten the chain to the door frame and the door. The chain is permanently attached to the part fastened to the door frame. The slotted keeper on the door allows the chain to be attached and removed easily by sliding into a groove. The design herein will not improve the mechanical reliability of the commercial door chain but will improve access controllability and provide increased protection to a residence or commercial property. The drilled hole 11 will be utilized by the solenoid shaft 6 which will plunge in the hole on the slotted keeper 3 attached to the door. It is clear that any fastening mechanism to secure the door chain to the door frame and the door can be used.

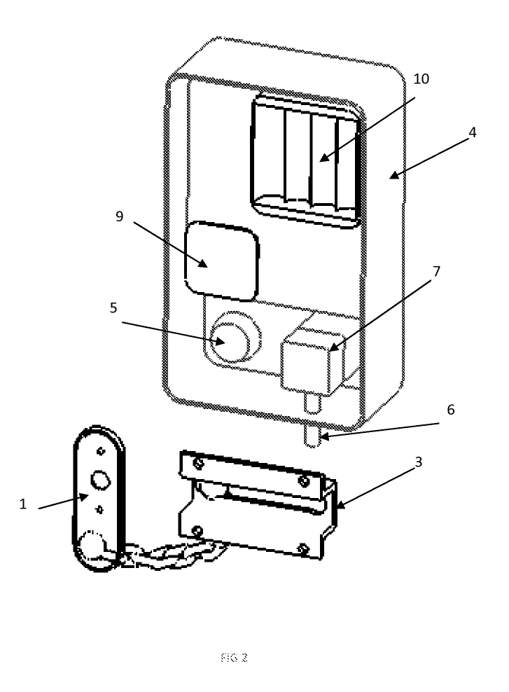

FIG. 2 depicts the rear side perspective view of the Electronic Door Chain. Here the open view of the main enclosure 4 can be seen which houses the battery holder 10, the electronics board 9, the solenoid body 7, the speaker 5, and the solenoid shaft 6.

The battery holder 10 consists of a holder for 8 AA size batteries at 1.5V each in two single rows which will provide 12 Vdc and act as the power supply for all the electronics and solenoid shaft 6. The holder dimensions are 2.5″ long×2.3″×0.63″ high and will be fitted inside the main enclosure 4. The holder is manufactured of unbreakable black plastic. The power out of the holder is two 6″ wire leads, which is used to distribute power to the components. Any power supply can be used as long as care is used to balance the power required by the various components.

The solenoid shaft 6 is inserted into a drilled hole 11 that is located on the slotted keeper 3. The shaft will then prevent sliding of the chain out of the groove. If the person wishes to remove the chain, one must first key in the access code on the access keypad 2. The solenoid is a push-type, spring-return solenoid. An 8 Ohm coil operates as low as 5 Vdc. The solenoid dimensions are 0.5″×0.43″ base×0.46″ tall U-frame. Two threaded mounting holes in base will be used to mount the solenoid to the enclosure. The shaft is a 0.05″ diameter plunger which protrudes 0.37″ when activated. The solenoid input is connected to the output of the access keypad. To limit the voltage supply to the solenoid to 5 Vdc, a 5 Vdc voltage regulator is used with a current limited resistor.

Additional embodiments can be added to enhance the performance of the invention, such as a smoke detection unit that automatically retracts the solenoid shaft or actuates any mechanism adopted. Also, a wired or wireless network device can be added to control the device remotely and monitor the door status. A final addition could be a remote control device that actuates the release mechanism from anywhere within a range to release the solenoid shaft and enable the chain to be removed.

We claim:

1. In combination with a door chain the improvements comprise of an electronically controlled solenoid shaft that plunges into a hole drilled into the slotted keeper once a preprogrammed access code is successfully executed to enable removal of the chain.
